(19) United States
(12) Patent Application Publication
(10) Pub. No.: US 2007/0041421 A1
(43) Pub. Date: Feb. 22, 2007

(54) Holographic element for stabilizing coupled laser and SHG resonators

(75) Inventors: Walter M. Duncan, Dallas, TX (US); John D. Jackson, Euless, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/465,397

(22) Filed: Aug. 17, 2006

Related U.S. Application Data
(60) Provisional application No. 60/709,258, filed on Aug. 18, 2005.

(51) Int. Cl. H01S 3/10; H01S 3/091; H01S 3/08

(52) U.S. Cl. 372/106; 372/71; 372/22

(57) ABSTRACT

It is often desirable to transform near-infrared lasers to lasers of visible light. Disclosed embodiments describe devices and techniques for efficiently doubling the frequency of a laser beam using volume holographic elements. A volume holographic element is placed between a pump laser and an SHG cavity. If the pump laser is unpolarized, such as the light of a VECSEL for example, then the volume holographic element may be operable to polarize the light to allow for efficient frequency doubling within the SHG cavity. The volume holographic element may also be operable to reflect back-propagating frequency-doubled photons, allowing for multiple conversion passes that generate and direct frequency-doubled photons out of the device, typically in a single beam. In such a case, the volume holographic element may also comprise a holographic skewing pattern. A single volume holographic element may accomplish multiple functions, or separate volume holographic elements could be used together to accomplish multiple functions for efficient frequency doubling.

### CROSS-REFERENCE TO RELATED APPLICATIONS

This application claims priority to U.S. Provisional Application Serial No. 60/709,258, filed Aug. 18, 2005, entitled “Holographic Element for Stabilizing Coupled VECSEL and SHG resonators,” which is incorporated herein by reference in its entirety.

### FIELD OF THE INVENTION

Disclosed embodiments relate generally to lasers, and more specifically to frequency doubling (of Vertical Extended Cavity Surface Emitting Lasers.

### BACKGROUND OF THE INVENTION

Visible red and near infrared lasers are common place in digital audio and video storage, remote sensing, optical communication, and a wide range of other products applications. Visible lasers, including the blue and green regions of the visible electro-magnetic spectrum (typically with wavelengths in the range of 400 to 550 nm), have found increasing uses in recent years in specific medical, data storage, display, industrial and military applications. While traditional gas and solid state lasers operating in the blue and green portions of the visible spectrum have found much application, these systems are often quite large, rather expensive to manufacture, and have poor reliability.

One of the most efficient classes of lasers currently known, by way of example, are the semi-conductor materials based, near-infrared lasers that typically emit coherent radiation at about half the frequency of visible light. These near-infrared lasers are relatively inexpensive to produce. Consequently, converting high efficiency near IR lasers to visible frequencies, using for example Non-Linear Optical (NLO) crystals, would be a desirable approach for production of coherent and monochromatic laser light at visible frequencies.

Propagating a laser through certain NLO crystals may, under some conditions, produce photons at the second harmonic of the laser's fundamental frequency. Second harmonic generation is a non-linear process, in which photons interact with a non-linear optical crystal, combining to form new photons with twice the energy, and therefore twice the frequency and half the wavelength, of the original, fundamental photons. For example, the non-linear crustal of a second harmonic generation process may convert two near-infrared photos into one visible photon with twice the energy and twice the frequency of an original near-infrared photon. So by propagating a near-infrared laser through the proper non-linear crystal, it may be possible to essentially double the frequently of the laser. This Second Harmonic Generation (SHG) effect occurring in non-linear optical crystals can be used to convert near-infrared light into the visible optical range. By using an SHG process to double the frequency of efficient near-infrared lasers, less expensive visible light lasers (typically green lasers) may be produced. Hence, frequency-doubled near IR lasers producing blue and green light have found a place in the marketplace.

SHG typically couples a second harmonic generator cavity (containing a non-linear crystal) to a pump laser cavity. The laser producing the pump wave beam passes through a non-linear optical crystal, typically referred to as a “doubling crystal”, within the second harmonic generation cavity. The doubling crystal's non-linear properties may then serve to double the frequency of the laser beam. Crystalline materials with a unit cell that lacks inversion symmetry can generally be used as the optically non-linear crystal for SHG.

When using an SHG cavity for frequency doubling, photons of the fundamental frequency (from the pump laser beam) are converted to frequency-doubled photons at a fairly low rate, such that the Second Harmonic (SH) beam produced would be too weak to be effective for many practical uses. Efficient doubling may be achieved, however, if the fundamental pump wave beam and the second harmonic wave beam are kept in phase as they pass through the non-linear optical crystal. Such “phase matching” is typically accomplished by property orienting the pump laser's wave propagation direction and polarization with respect to the non-linear optical crystal (with perhaps the temperature of the non-linear material also being controlled). Then, the fundamental pump wave beam and the second harmonic wave beam would experience the same index of refraction and propagate in phase through the non-linear crystal. In this instance, referred to as angle-tuned birefreingent phase matching, polarized light from the fundamental pump wave beam propagates through the non-linear material in phase with the second harmonic wave beam, resulting in high efficiency second harmonic conversion.

Only certain, specific non-linear crystals have the angle tuned birefreingent phase matching (birefringent phase matching) properties necessary for efficient frequency doubling. An alternative to phase matching is quasi-phase matching, where a periodically poled non-linear optical crystal (such as periodically poled lithium niobate, by way of example) is used for efficient SHG of light. So for other non-linear crystals, efficient frequency doubling may be possible via a process referred to as quasi-phase matching, where the non-linear crystal is periodically poled to produce phase matching. Using known techniques such as birefringent phase matching or quasi-phase matching, an SHG cavity may be configured for efficient frequency doubling based upon the specific non-linear crystal in use.

Once the SHG cavity is phase matched (or quasi-phase matched) for efficient doubling, a percentage of any polarized laser light passing through the SHG cavity will be doubled. However, efficient frequency doubling will only occur for a single polarization correctly aligned to the crystallographic and/or periodically poled waveguide directions in the non-linear crystal. In other words, the polarization of the fundamental wavelength beam typically should be oriented with respect to the angle tuned birefringent axis in the non-linear optical crystal, in quasi-phase matching, the polarization orientation of the fundamental beam does not inherently require polarization, but in order to achieve large recycled waves of the fundamental beam, net polarization should be fixed for maximum doubling efficiency. In addition the output couplers of a laser, including intracavity doubling lasers, are most efficient for a preferred polarization. As a result, conventional frequency doubling techniques tend to use polarized pump laser sources. If the laser operating at the fundamental frequency for doubling is unpolarized or does not have a stable polarization in time, then polarization would be necessary to obtain efficient doubling.

Vertical Extended Cavity Surface Emitting Lasers (VECSELs) are a type of efficient, compact, and relatively inexpensive near-infrared laser source, and hence may be useful as the laser for pumping SHG cavities (to produce green or blue laser light). VECSELS are semiconductor laser generators, which efficiently produce near-infrared light frequencies using short gain cavities. Typically, cavity mirrors are formed on opposite ends of a semiconductor cain region grown by epitaxial methods on a semiconductor substrate. Electrical or optical pumping generates a laser beam emitted in a direction orthogonal to the plane of the substrate. In this way, VECSELs may generate near-infrared lasers from a short semiconductor cavity. Given their small profile, VECSELs may be desirable as practical SHG pump lasers. Unfortunately, VECSELs are not inherently polarized. So in order to be useful for SHG the light from the VECSEL would typically first be polarized, allowing for an efficient conversion process.

If a laser is not inherently polarized, a method of polarization stabilization is needed to efficiently frequency double this light. Current technology for polarization uses various sorts of fairly large polarizer element between the VECSEL and the SHG cavity. These conventional polarizers are large because they include forty-five degree interfaces, as found in Glan-Thompson, Glan-Taylor, or dichroic style polarizers, for example. In addition, by extending the optical cavity length, these conventional polarizers require precise alignment.

FIG. 1 illustrates the use of a Glan-type polarizer. The Glan polarizer is a large element, and when it is used in conjunction with an SHG (with an output coupler), frequency doubling is limited to a single pass through the SHG (since the Glan polarizer does not direct any back-propagating doubled photons out of the SHG cavity). FIG. 2 illustrates the use of a dichroic polarizer. Again, the dichroic polarizer occupies substantial space, since it must be oriented at an angle. This angled approach also requires more precise alignment, in order for optimal polarization. And if the dichroic polarizer is designed to reflect back-propagating doubled photons (as shown in FIG. 2), then it would essentially create multiple output beams of frequency-doubled light (since the angle of the dichroic polarizer would not allow simple reflection of the doubled photons back along a path substantially similar to that of the fundamental beam). As FIG. 2 illustrates, a second mirror would typically be used, so that back-propagating frequency-doubled light reflected off of the angled dichroic polarizer would be directed out as a second beam, parallel to the original frequency-doubled beam. So, while conventional arrangements of VECSELs in conjunction with a large polarizer and a SHG cavity may produce fairly efficient lasers having light with visible frequencies, their bulk and precise alignment tolerances reduce their effectiveness for real-world applications.

### SUMMARY OF THE INVENTION

The disclosed embodiments generally use a volume holographic element to stabilize the polarization of the pump laser light. In addition, the holographic element may be formed to serve as a dichroic reflector, allowing for repeated passes of the pump laser wave beam light (of fundamental frequency) through the SHG doubling crystal in order to further increase the effectiveness of the SHG cavity while directing the doubled light out of the SHG cavity. By using such a thin, transmissive holographic element in place of conventional large polarizers, the length of the optical cavity may be substantially reduced. In addition, the flat holographic element may be placed normal to the propagation direction (axis) of the pump beam, providing for simpler, effective alignment of the various elements.

### BRIEF DESCRIPTION OF THE DRAWINGS

Embodiments are illustrated by way of example in accompanying figures, in which like reference numbers indicate like parts, and in which:

FIG. 1 is a schematic diagram of a conventionally SHG technique using a Glan Polarizer;

FIG. 2 is a schematic diagram of a conventional SHG technique using a standard dichroic polarizer;

FIG. 3 is a schematic diagram of a disclosed embodiment in which the holographic element serves as a polarizer;

FIG. 4 is a schematic diagram of a disclosed embodiment in which the holographic element serves as a dichroic reflector; and

FIG. 5 is a schematic diagram of a disclosed embodiment in which a holographic element serves as both a polarizer and a dichroic reflector and is used in conjunction with a second harmonic generation cavity to efficiency produce frequency-doubled visible light from a VECSEL.

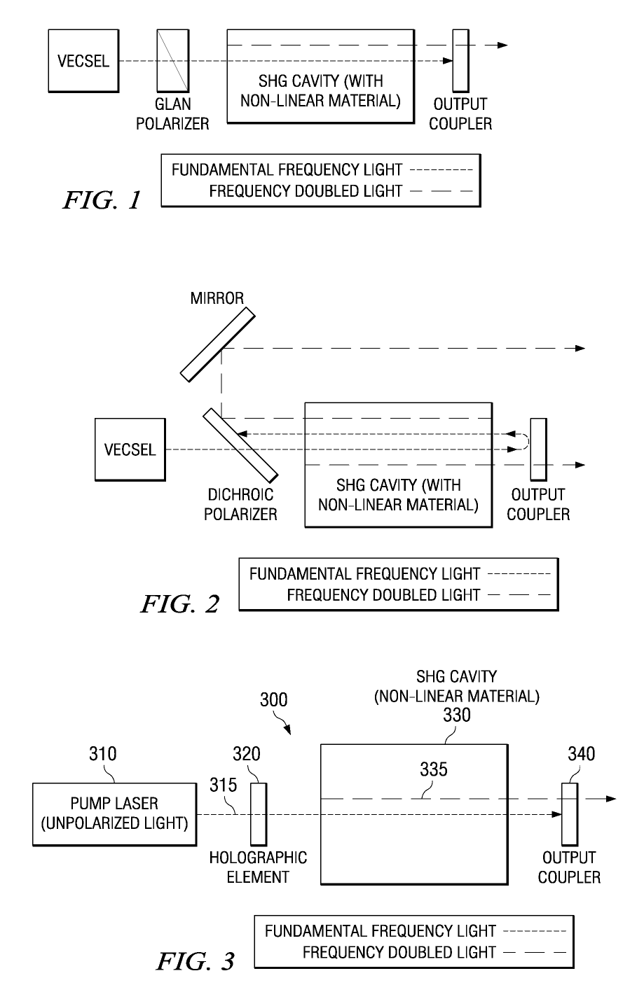

### DETAILED DESCRIPTION OF EMBODIMENTS

Volume holographic elements may effectively serve several functions that may improve the process by which a beam of fundamental laser light may be doubled using an SHG cavity. A volume holographic element may act as a polarizer, so that an unpolarized fundamental pump wave beam may be efficiently doubled by the non-linear crystal within the SHG cavity. Beneficially, a volume holographic element polarizer would be relatively thin, allowing for a more compact laser device. Also, a volume hologram may act as a dichroic reflector, reflecting back-propagating doubled photons out of the SHG cavity. A volume holographic element might also include a holographic pattern that skews the path of reflected back-propagating doubled photons, to ensure that the beam of doubled photons does not interfere destructively with the fundamental beam from the pump laser. Several of these functions may operate together, to provide for more effective frequency doubling. Indeed, while separate holograms could be used for each function, two or more such functions might also be combined in a single volume holographic element, formed to effectively perform several functions simultaneously.

FIG. 3 schematically illustrates an exemplary disclosed embodiment in which the volume hologram acts to polarize light. The disclosed embodiment of a laser device 300 shown in FIG. 3 comprises a pump laser 310 of unpolarized light, a volume phonographic element 320, and an SHG cavity 330. By way of example, the pump laser 310 could be either a VECSEL or a VCSEL (Vertical Cavity Surface Emitting Laser). Alternatively, the pump laser 310 could be an edge emitting or grating coupled surface emitting laser. While the stimulated photons which result from laser action in such pump lasers would generally emit in polarized groups, the polarization state of a laser may change with time unless there is a component within the laser cavity that acts to stabilize the net polarization. An example of such a stabilizing component would be the Brewster window on the output of a gas laser. But in VECSELs, VCSELs, edge emitters, and grating surface lasers, for example, there may not be enough structural anisotropy in the device to stabilize the emission from a particular polarization, resulting in randomly polarized light or unstable polarization of the pump wave laser light.

The SHG cavity 330 is operable to double the frequency of the pump laser light. Typically, the SHG cavity 330 comprises a nonlinear crystal, and is configured as appropriate given the particular non-linear crystal in order to effectuate frequency doubling of the fundamental pump laser beam (for example, the SHG cavity may be phase matched or quasi-phase matched). The SHG cavity 330 may also comprise an output coupler 340. Typically, the output coupler 340 would be positioned on the opposite side of the SHG cavity as the pump laser 310 and the volume holographic element 320. The output coupler 340 generally serves to reflect light of the fundamental frequency, while allowing frequency-doubled light to pass unobstructed, exiting the laser device 300. In other words, the output coupler 340 is typically transmissive of frequency-doubled light, while it is substantially reflective of light of the fundamental pump wave beam frequency.

The volume holographic element 320 of FIG. 3 is operable to act as a polarizer. Specifically, the volume holographic element 320 would be configured to polarize the fundamental pump wave beam of light from the pump laser 310 in order to allow efficient frequency doubling via the non-linear crystal in the SHG cavity 330. In general, the volume holographic element 320 would be configured not to filter undesired polarizations, but rather to force stimulated emissions to occur in the desired polarization direction for frequency doubling. In other words, the volume holographic element 320 of FIG. 3 is generally formed to favor propagation of only a single polarization of light, correctly aligned to the crystallographic and/or periodically poled crystal directions in the non-linear optical crystal. By properly aligning the polarization with the non-linear crystal's direction of propagation for efficient frequency doubling, the volume holographic element 320 allows the pump wave beam to be effectively doubled within the SHG cavity 330 of FIG. 3.

Fundamental frequency light 315 of the pump wave beam generated by the pump laser 310 would pass through the volume holographic element 320, being properly polarized, and would then enter the SHG cavity 330. In the SHG cavity 330, a portion of the photons of the fundamental pump wave beam 315 from the pump laser 310 would be frequency-doubled by passing through) the non-linear crystal (with the efficiency of the doubling process depending upon the properties of the non-linear crystal, polarization, phase-matching (or quasi-phase matching), physical conditions, etc.), forming an SH beam 335 of photons with frequency twice that of the fundamental pump wave beam 315. The frequency-doubled SH beam 335 would generally proceed along substantially the same path as the fundamental beam 315 (although in FIG. 3, the SH beam 335 is shown as parallel to the fundamental beam 315 for clarity). Both the fundamental beam 315 and the SH beam 335 would be directed to the output coupler 340, which would allow the SH beam 335 to exit the laser device 300 while reflecting the fundamental beam 315 back into the SHG cavity 300. Thus, only frequency-doubled light generated in the SHG cavity 330 would typically exit the laser device 300. In this way, the pump wave beam from the pump laser 310 may be converted efficiently to frequency-doubled light.

In another disclosed embodiment, illustrated by FIG. 4, the volume holographic element acts as a dichroic reflector. In this embodiment, the laser device 400 comprises a pump laser 410, a volume holographic element 420, and an SHG cavity 430 with an output coupler 440 (as before, the output coupler 440 may be located outside of the SHG cavity). The pump laser 410 of this embodiment generally emits a fundamental pump wave beam 415 of polarized light.

The volume holographic element 420 in the embodiment of FIG. 4 acts as a dichroic reflector. In general it would allow photons of the fundamental frequency (associated with the fundamental pump wave beam 415 from the pump laser) to pass through it from the direction of the pump laser 410 moving towards the SHG cavity 430. But the volume holographic element 420 would reflect frequency-doubled photons propagating from the SHG cavity 430 towards the pump laser 410. In other words, the volume holographic element 420 of FIG. 4 would be operable to reflect back-propagating doubled photons (while typically transmitting any back-propagating fundamental frequency photons so that they may be recycled by reflecting from the pump laser 410). The process of recirculating fundamental photons back and forth through the SHG cavity 430 allows effective frequency doubling, even if the efficiency of conversion is fairly low for a single pass through the SHG cavity 430.

The SHG cavity 430 comprises a nonlinear crystal, which may act upon light passing through it and double the frequency of at least a portion of the photons of the fundamental pump wave beam. The output coupler 440 (which may be part of the SHG cavity 430 or may be located externally) acts to reflect photons of the fundamental frequency, while allowing frequency-doubled photons to pass through and exit the laser device 400.

The fundamental pump wave beam 415 emitted by the pump laser 410 passes through the volume holographic element 420, which does not obstruct the light of the fundamental beam 415. The fundamental beam 415 then enters the SHG cavity 430. As the fundamental beam 415 passes through the non-linear crystal within the SHG cavity 430 a portion of its photons would be frequency-doubled. Thus, as the fundamental pump wave beam 415 traverses the SHG cavity 430, a Second Harmonic (SH) beam 432 is formed. This SH beam 432 would consist of photons with frequency twice that of the fundamental beam 415 photons, and would follow substantially the same path as the fundamental pump wave beam 415 (although for the sake of clarity, it is shown as a parallel beam in the schematic of FIG. 4).

Upon encountering the output coupler 440, the SH beam 432 would pass through unobstructed, exiting the laser device 400. The fundamental beam 415, however, would be reflected back into the SHG cavity 430. As the reflected fundamental beam 434 passes through the SHG cavity 430 (back-propagating towards the volume holographic element 420 and the pump laser 410), it would again pass through the non-linear crystal. As a result, some portion of the remaining (un-converted) fundamental photons in the reflected (back-propagating) fundamental beam 434 would be transformed into frequency-doubled photons during this back-propagation. Thus, a back-propagating SH beam 436 may be generated by photons of the fundamental frequency that were not frequency-doubled on the first pass through the SHG cavity 430, but were reflected back into the SHG cavity 430 by the output coupler 440.

As the back-propagating SH beam 436 reaches the volume holographic element 420, it would be reflected back towards the output coupler 440 (due to the hologram's properties as a dichroic reflector). In this way, any backward propagating frequency-doubled photons generated by the reflected fundamental beam 434 would be directed out of the laser device 400 via the output coupler 440 (in a beam shown in FIG. 4 as frequency-doubled beam 438). Thus, the embodiment of FIG. 4 emits a single output beam of frequency-doubled photons via the output coupler 440.

The portion of the back-propagating fundamental beam 434, consisting of fundamental frequency photons reflected from the output coupler 440 back into the SHG cavity, that does not convert while back-propagating through the nonlinear crystal may also be reflected back into the SHG cavity by the pump laser cavity 410, depending upon the nature of the pump laser 410. If the pump laser 410 is configured to effectively redirect and/or reuse the reflected fundamental beam 434 (so that these photons are once again introduced into the SHG cavity 430), then the volume holographic element 420 would typically be configured to allow the reflected (back-propagating) fundamental beam 434 to pass unobstructed and unchanged.

Photons of the fundamental frequency would typically pass back and fourth through the nonlinear crystal within the SHG cavity 430, with some portion of the un-converted photons being frequency-doubled each passes through the SHG cavity 430. This process would continue indefinitely until the photons of the fundamental frequency had been converted to frequency-doubled photons and emitted from the laser device 400. In other words, the reflected fundamental beam 434 would typically recirculate within the SHG cavity 430, passing through the nonlinear crystal multiple times in order to improve the conversion process to frequency-doubled photons. In this way, multiple passes through the SHG cavity 430 may enable substantially all of the fundamental photons from the pump laser 410 to be converted to frequency-doubled photons, emitted as an SH beam from the output coupler 440.

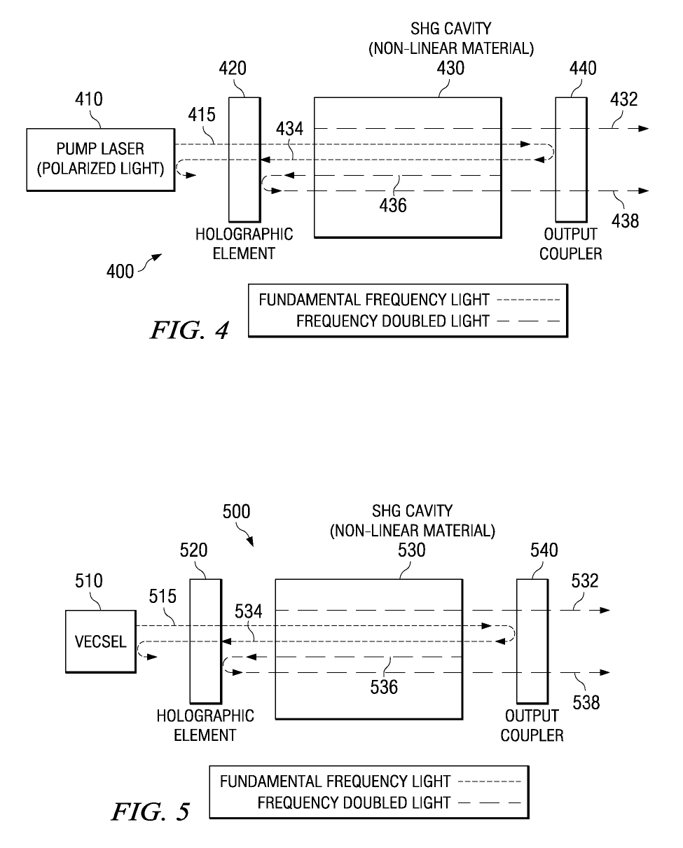

FIG. 5 schematically illustrates another exemplary disclosed embodiment. In FIG. 5, the volume holographic element is operable to polarize light and to act as a dichroic reflector. By combining these two functions together, an unpolarized laser, such as a VECSEL, may be efficiently converted to a frequency-doubled laser. This may be particularly useful in conjunction with a VECSEL, since it allows the laser device 500 to produce visible light laser beam's using a short cavity near-infrared pump laser. And while only a single volume holographic element 520 is shown in FIG. 5, it should be understood that separate volume holographic elements could be used in conjunction to perform these multiple functions. Alternatively, a single volume holographic element may be formed to perform some or all of the functions attributed to a volume holographic element in the present disclosed embodiment.

The disclosed embodiment of FIG. 5 comprises a VECSEL 510, a volume holographic element 520, and an SHG cavity 530. The SHG cavity 530 typically comprises a non-linear crystal for frequency doubling and an output coupler 540. The volume holographic element 520 is generally located between the VECSEL 510 and the SHG cavity 530, and as stated above, the volume holographic element 520 is operable to polarize light and to serve as a dichroic reflector.

The disclosed embodiment of FIG. 5, for doubling the frequency of an unpolarized pump laser using an SHG cavity and a volume holographic element, may be used to transform the light of any pump laser beam, such as VECSELs, VCSELs, edge emitters or grating surface emitters. Typically, the pump laser would be a near-infrared laser, so that the doubled light would produce a laser within the visible spectrum. In the exemplary embodiment of FIG. 5, the pump laser would be a VECSEL 510, but alternatively, other types of lasers, such as VCSELS, edge emitting, or grating coupled surface emitting lasers, could be used.

The SHG cavity 530 comprises a non-linear optical crystal, and typically would be configured to effectuate efficient frequency doubling of the fundamental pump wave beam. For example, the SHG cavity 530 may be phase matched or quasi-phase matched, depending upon the non-linear crystal within the cavity. Possible nonlinear crystals would include, by way of example, Lithium Niobate (LN), Lithium Tantalate (LT), Potassium Titanyl Phosphate (KTP), Lithium Titanyl Arsenate (RTA), Potassium Niobate (KN), Potassium Lithium Niobate (KLN), Periodically Poled Lithium Niobate (PPLN), Periodically Poled Lithium Tantalate (PPLT), Stoichiometric Lithium Niobate, MgO doped Lithium Niobate, Beta Barium Borate (BBO), and Lithium Borate (LBO).

The non-linear crystal would act to double the frequency of laser light directed through it, with the nonlinear crystal generally being cut and oriented so that fundamental and second harmonic light would propagate at the same speed through the SHG cavity 530. The SHG cavity 530 may also comprise an output coupler 540, which acts to reflect laser light of the fundamental frequency back through the non-linear crystal, while allowing second harmonic frequency-doubled light to exit the SHG cavity 530. In some embodiments, the output coupler 540 could be located outside of the SHG cavity 530, reflecting light of the fundamental frequency back into the SHG cavity 530. While the output coupler 540 does not have to be a perfect reflector of photons of the fundamental frequency, preferably it would reflect a substantial portion of such un-converted photons.

The volume holographic element 520 is generally a thin film of photoactive agent printed in or on glass. The hologram would generally be made from an inorganic oxide photoreactive material, as many organic emulsion materials would likely fail in the high optical field of a laser. Typically, the volume holographic element 520 would be formed by projecting the desired pattern into the base material using interferometry of light. In the embodiment shown in FIG. 5, the volume holographic element 520 is typically placed between the VECSEL 510 and the SHG cavity 530, typically substantially normal to the axis of propagation of the laser light.

The volume holographic element 520 would be formed so that it is operable to stabilize the polarization of the light emitted by the VECSEL 510 and entering the SHG cavity 530. Typically, the volume holographic element 520 would be formed to favor propagation of only a single polarization, correctly aligned to the crystallographic and/or periodically poled crystal direction in the nonlinear crystal of the SHG cavity 530. This function of the volume holographic element 510 is important for efficient frequency doubling if the pump laser emits unpolarized light, such as the VECSEL 510 of the present embodiment. The volume holographic element 510 does not generally filter the undesired polarizations, but rather forces stimulated emissions to occur in the desired polarization direction. In other words, the holographic polarizer stabilizes the emission by initially allowing spontaneous light with an allowed polarization to exit the cavity. The photons stimulated by these spontaneous photons would then have the same polarization state. In this way, the volume holographic element 520 serves the purpose of providing polarized light, allowing for efficient frequency doubling within the SHG cavity 530.

In order to further enhance the performance of the frequency doubling SHG cavity 530, the volume holographic element 520 may also be formed to serve as a dichroic reflector. In general, such a volume holographic element 520 would allow photons of the fundamental frequency (associated with the fundamental pump wave beam 515 from the VECSEL 510) to pass thorough it from the direction of the VECSEL 510 moving towards the SHG cavity 530 (in a single polarization). But the volume holographic element 520 would reflect frequency-doubled photons moving from the SHG cavity 530 towards the VECSEL 510. In other words, the volume holographic elements 520 would allow fundamental light from the VECSEL 510 to pass into the SHG cavity 530, but would reflect back-propagating frequency-doubled light from the SHG cavity 530 back into the SHG cavity 530 (and out of the laser device 500 via the output coupler 540).

By providing a volume holographic element that serves as a dichroic reflector as well as a polarizer, frequency doubling of the fundamental photons from the VECSEL 510 within the SHG cavity 530 may be improved. Light of the original, fundamental frequency would typically reflect back and forth within the SHG cavity 530 between the output couple 540 and the pump laser 510. Each pass through the SHG cavity 530, the fundamental light would pass through the non-linear crystal, and some portion of the fundamental photons would be frequency-doubled. The frequency-doubled light from each pass would be directed out of the SHG cavity 530 thorough the output coupler 540, with any frequency-doubled back-propagating light being reflected by the holographic element 520 so that it exits the SHG cavity 530 via the output coupler 540.

Thus, the fundamental pump wave beam 515 emitted by the VECSEL 510 passes through the volume holographic element 520, which does not obstruct the light of the fundamental beam 515, but merely polarizes the light in preparation for efficient frequency doubling within the SHG cavity 530. The fundamental beam 515 then enters the SHG cavity 530. As the fundamental pump wave beam 515 passes through the non-linear crystal within the SHG cavity 530, a portion of its photons would be frequency-doubled. Thus, as the fundamental beam 515 traverses the SHG cavity 530, an SH beam 532 is formed. This SH beam 532 would consist of photons with a frequency twice that of the fundamental beam photons, and would follow substantially the same path as the fundamental beam 515 (although for the sake of clarity, beams are shown as being parallel in the schematic of FIG. 5).

Upon encountering the output coupler 540, the SH beam 532 would pass through unobstructed, exiting the laser device 500. The fundamental beam 515, however, would be reflected back into the SHG cavity 530. As the reflected fundamental beam 534 passes thorough the SHG cavity 530 (back-propagating towards the volume holographic element 520 and the VECSEL 510), it would again pass through the non-linear crystal. As a result, some portion of the un-converted fundamental photons in the reflected (back-propagating) fundamental beam 534 would be transformed into frequency-doubled photons. Thus, a back-propagating SH beam 536 may be generated by photons of the fundamental frequency that were not frequency-doubled on the first pass through the SHG cavity 530 and that were reflected back into the SHG cavity 530 by the output coupler 540.

As the back-propagating SH beam 536 reaches the volume holographic element 520, it would be reflected back towards the output coupler 540 (due to the volume holographic element's 520 reflective nature at second harmonic frequencies). In this way, any backward propagating frequency-doubled photons generated by the reflected fundamental beam 534 would be directed out the laser device 500 via the output coupler 540 (in a beam shown in FIG. 5 as frequency-doubled beam 538). The reflected fundamental beam 534 may be allowed to pass back into the VECSEL cavity 510, depending upon the nature of the VECSEL 510. If the VECSEL 510 is configured to effectively redirect and/or reuse the reflected fundamental beam 534 (so that these photons would once again be introduced into the SHG cavity 530), then the volume holographic element 520 might be configured to allow the reflected fundamental beam 534 to pass unobstructed and unchanged, allowing the photons of the fundamental frequency to recirculate between the output coupler and the VECSEL 510.

Un-converted photons of the fundamental frequency would pass back and forth through the non-linear crystal within the SHG cavity 530, with some portion of the un-converted photons being frequency-doubled each pass through the SHG cavity 530. This process would continue until substantially all of the fundamental photons have been converted to SHG photons. In other words, the reflected fundamental beam 534 may recirculate within the SHG cavity 530, possibly passing through the non-linear crystal multiple times in order to improve the conversion process to frequency-doubled photons. This back-and-forth reflection would continue until approximately all of the original, fundamental light photons have been converted to frequency-doubled photons, and the number of passes would depend generally upon the geometry and physical characteristics of the non-linear crystal. The number of passes of light through the SHG cavity would depend on a number of factors, such as the cavity resonator design (e.g. stable vs. unstable resonators), the reflectivity of the volume holographic element, and the reflectivity of the output coupler One pass to hundreds of cycles within the cavity might be required in order to convert the original, fundamental photons to frequency-doubled photons. And although the schematic diagram of FIG. 5 illustrates each of the beams as discretely separate and parallel, such illustration is merely for clarity; generally, all beams would follow substantially the same path through the SHG cavity 530. Thus, the disclosed embodiment of FIG. 5 may efficiently convert the near-infrared light of the VECSEL 510 into a single, visible light laser beam, propagating outward from the output coupler 540 of the SHG cavity 530.

It may also be useful to form the volume holographic element 520 with a holographic pattern designed to slightly skew the path of reflected frequency-doubled photons, so that any reflected frequency-doubled light 538 (propagating in the same direction as the original fundamental beam 515, towards the output coupler 540) would not create destructive interference with the optical field of the original, fundamental with frequencies within the SHG cavity 530. Generally, the holographic pattern would slightly skew the path of reflected frequency-doubled light beams 538 (from the various passes through the SHG cavity), so that it would not lie directly atop that of the original, fundamental light beams 534 (and any recirculating photons of the fundamental frequency). Such a skewing holographic pattern within the volume holographic element 520 may help to ensure that the doubled light will not create destructive interference with the optical field of the original, fundamental light, allowing for more effective frequency doubling within the SHG cavity 530.

Thus, in the embodiment illustrated in FIG. 5, the volume holographic element 520 is operable to perform multiple functions. It serves to polarize the light from the VECSEL 510, preparing it for efficient doubling within the SHG cavity 530, and also serves as a dichroic reflector, reflecting back-propagating frequency-doubled photons out of the laser device 500 through the output coupler 540 (so that a single output beam of visible light emerges from the output coupler 540). In addition, the volume holographic element 520 may be formed with a holographic skewing pattern, so that reflected frequency-doubled photons may not interact destructively with photons of the fundamental frequency. While a single volume hologram element may be formed to perform all of these functions (acting to polarize reflect back-propagating doubled photons, and provide a skewing holographic pattern), separate holographic elements could be formed for each specific function.

So in the embodiment of FIG. 5, volume holographic elements placed at normal to the propagation axis are used to hold stable the polarization and to serve as a frequency filter for the light between a VECSEL laser and SHG cavity. Because of the thin nature of such holographic elements, gain and doubling elements can be placed in near proximity to each other, significantly reducing cavity lengths and allowing components to be placed at near normal incidence to the propagating beam, simplifying alignment.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background of the Invention” is not to be construed as an admission that certain technology is prior art to any invention(s) in this disclosure. Neither is the “Brief Summary of the Invention” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A device comprising:
a pump laser operable to emit a pump wave beam;
a volume holographic element; and
an SHG cavity operable to double the frequency of photons of a fundamental beam;
wherein the volume holographic element is located between the pump laser and the SHG cavity such that the pump wave beam emitted by the pump laser passes through the volume holographic element before entering the SHG cavity.

2. A device as in claim 1, wherein the pump laser emits a beam of unpolarized light, and the volume holographic element is operable to polarize light.

3. A device as in claim 2 wherein:
the SHG cavity comprises a non-linear crystal with a direction of propagation for frequency doubling; and
the volume holographic element polarizes light so that it is aligned with the non-linear crystal's direction of propagation for frequency doubling.

4. A device as in claim 3, wherein:
the nonlinear crystal is phase matched; and
the volume holographic element polarizes light so that it is aligned with the crystallographic direction of the phase matched non-linear crystal.

5. A device as in claim 3, wherein:
the non-linear crystal is quasi-phase matched; and
the volume holographic element polarizes light so that it is aligned with the periodically poled crystal direction of the non-linear crystal.

6. A device as in claim 1, wherein the volume holographic element is operable to reflect back-propagating frequency-doubled photons moving from the SHG cavity towards the pump laser.

7. A device as in claim 6, wherein the volume holographic element comprises a holographic pattern operable to skew the path of reflected frequency-doubled photons to prevent destructive interference with fundamental frequency photons.

8. A device as in claim 6, wherein the SHG cavity comprises an output coupler located on the opposite side of the SHG cavity away from the volume holographic element and operable to reflect photons of the fundamental frequency while allowing frequency-doubled photons to pass.

9. A device as in claim 8, wherein the pump laser emits a beam of unpolarized light, and the volume holographic element is further operable to polarize light.

10. A device as in claim 9, wherein:
the SHG cavity further comprises a non-linear crystal with a direction of propagation for frequency doubling; and
the volume holographic element polarizes light so that it is aligned with the non-linear crystal's direction of propagation for frequency doubling.

11. A device as in claim 10, wherein:
the non-linear crystal is phase matched; and
the volume holographic element polarizes tight so that it is aligned with the crystallographic direction of the phase matched non-linear crystal.

12. A device as in claim 10, wherein:
the non-linear crystal is quasi-phase matched; and
the volume holographic element polarizes tight so that it is aligned with the periodically poled crystal direction of the non-linear crystal.

13. A device as in claim 10, wherein the volume holographic element comprises a holographic pattern operable to skew the path of reflected frequency-doubled photons to prevent destructive interference with fundamental frequency photons.

14. A device as in claim 10, wherein:
the volume holographic element comprises a plurality of holograms; and
the first hologram is operable to polarize light, and the second hologram is operable to reflect back-propagating frequency-doubled photons.

15. A device as in claim 14, wherein the volume holographic element further comprises a third hologram operable to skew the path of reflected frequency-doubled photons to prevent destructive interference with fundamental frequency photons.

16. A device comprising:
a pump laser operable to emit a pump wave beam;
a volume holographic element;
an SHG cavity operable to double the frequency of photons of the fundamental beam; and
an output coupler operable to reflect photons of the fundamental frequency while allowing frequency-doubled photons to pass;
wherein the volume holographic element is located between the pump laser and the SHG cavity, and the output coupler is located on the opposite side of the SHG cavity away from the pump laser and the volume holographic element, such that the pump wave beam emitted by the pump laser passes through the volume holographic element and through the SHG cavity to interact with the output coupler.

17. A device as in claim 16, wherein the volume holographic element is operable to reflect back-propagating frequency-doubled photons moving from the SHG cavity towards the pump laser, while allowing photons of the fundamental frequency to pass through when propagating in the direction from the pump laser towards the SHG cavity.

18. A device as in claim 17, wherein the volume holographic element comprises a holographic pattern operable to skew the path of reflected frequency-doubled photons to prevent destructive interference with fundamental frequency photons.

19. A device as in claim 16, wherein:
the pump laser emits a beam of unpolarized light;
the SHG cavity comprises non-linear crystal with a direction of propagation for frequency doubling; and
the volume holographic element is operable to polarize light so that it is aligned with the non-linear crystal's direction of propagation for frequency doubling.

20. A device as in claim 19, wherein the pump laser comprises a VECSEL.

21. A device as in claim 20, wherein the volume holographic element is further operable to reflect back-propagating frequency-doubled photons moving from the SHG cavity towards the pump laser, while allowing photons of the fundamental frequency to pass through when propagating in the direction from the pump laser towards the SHG cavity.

22. A device as in claim 21, wherein:
the non-linear crystal is phase matched; and
the volume holographic element polarizes light so that it is aligned with the crystallographic direction of the phase matched non-linear crystal.

23. A device as in claim 21, wherein:
the non-linear crystal comprises a periodically poled crystal; and
the volume holographic element polarizes light so that it is aligned with the periodically poled crystal direction of the non-linear crystal.

24. A device as in claim 21, wherein:
the volume holographic element comprises a plurality of holograms; and
the first hologram is operable to polarize light, and the second hologram is operable to reflect back-propagating frequency-doubled photons.

25. A device as in claim 21, wherein a single hologram is operable to polarize light and to reflect back-propagating frequency-doubled photons.

26. A device as in claim 24, wherein the volume holographic element further comprises a third hologram operable to skew the path of reflected frequency-doubled photons to prevent destructive interference with fundamental frequency photons.

27. A device comprising:
an SHG cavity comprising a non-linear crystal operable to double the frequency of photons of a fundamental pump wave beam; and
one or more volume holographic elements;
wherein the one or more volume holographic elements are located in proximity to the SHG cavity so that light of the fundamental beam first passes through the one or more volume holographic elements before entering the SHG cavity.

28. A device as in claim 27, wherein the one or more volume holographic elements are operable to polarize light so that it is aligned with the non-linear crystal's direction of propagation for frequency doubling.

29. A device as in claim 27, wherein:
the SHG cavity further comprises an output coupler located on the opposite side of the SHG cavity away from the one or more volume holographic elements and operable to reflect photons of the fundamental frequency while allowing frequency-doubled photons to pass; and
the one or more volume holographic elements are operable to reflect back-propagating frequency-doubled photons moving from the SHG cavity towards the volume holographic elements, while allowing photons of the fundamental frequency to pass through when propagating in the direction from the volume holographic elements towards the SHG cavity.

30. A device as in claim 29, wherein the one or more volume holographic elements comprise a holographic pattern operable to stew the path of reflected frequency-doubled photons to prevent destructive interference with fundamental frequency photons.

31. A device as in claim 29, wherein the one or more volume holographic elements are further operable to polarize light so that it is aligned with the non-linear crystal's direction of propagating for frequency doubling.

32. A device as in claim 31, wherein the one or more volume holographic elements comprise a holographic pattern operable to skew the path of reflected frequency-doubled photons to prevent destructive interference with fundamental frequency photons.
